(19) United States
(12) Patent Application Publication
(10) Pub. No.: US 2008/0125556 A1
(43) Pub. Date: May 29, 2008

(54) Method For Producing Cyclic Olefin Addition Copolymer, Cyclic Olefin Addition Copolymer And Use Thereof

(75) Inventors: Kenzo Ohkita, Tokyo (JP); Noboru Oshima, Tokyo (JP); Nobuyuki Sakabe, Tokyo (JP); Katsutoshi Sawada, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: JSR CORPORATION, Chuo-ku ,Tokyo (JP)

(21) Appl. No.: 11/722,525

(22) PCT Filed: Dec. 5, 2005
(86) PCT No.: PCT/JP2005/022304

§ 371 Date: Jun. 22, 2007

(30) Foreign Application Priority Data
Dec. 22, 2004 (JP) 2004-371326

(51) Int. Cl. C08F 4/60

(52) U.S. Cl. 526/145

(57) ABSTRACT

The present invention provides a method for producing a cyclic olefin addition copolymer wherein a monomer composition containing 5 to 80 mol % of a cyclic olefin having a substituent selected from alkyl groups, alkylsilyl group, and alkylsilylmethyl group represented by formula (1) below and 20 to 95 mol % of a cyclic olefin represented by formula (2) below is addition-copolymerized in the presence of a palladium-based multicomponent catalyst containing a specific palladium compound (i), a specific phosphorus compound (ii), and an ionic boron compound or an ionic aluminum compound (iii):

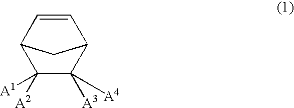

(one of A¹ to A⁴ is a C₄₋₅ alkyl group, trimethylsilyl group, or trimethylsilylmethyl group, and the others each independently are a hydrogen atom, halogen atom, or methyl group)

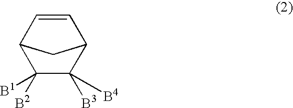

(B¹ to B⁴ are each independently a hydrogen atom, methyl group, or halogen atom.)

### TECHNICAL FIELD

The present invention relates to a method for producing a cyclic olefin addition copolymer, a cyclic olefin addition copolymer, and use thereof. More particularly, the present invention relates to a method for producing a cyclic olefin addition copolymer in which a cyclic olefin having a substituent selected from a specific alkyl group, a specific alkylsilyl group, or a specific alkylsilylmethyl group is addition-copolymerized with a specific cyclic olefin in the presence of a specific palladium-based multicomponent catalyst; a cyclic olefin addition copolymer suitable for producing films or sheets excellent in transparency, heat resistance, low water absorbency, mechanical strength, smoothness, and toughness; and use thereof.

### BACKGROUND ART

It is known that addition polymer of bicyclo[2.2.1]hept-2-ene (norbornene) has a glass transition temperature above 300° C. and can be produced with a titanium catalyst, a zirconium catalyst, a cobalt catalyst, a nickel catalyst, a palladium catalyst, or the like (Non-Patent Document 1). In addition, Patent Document 1 discloses a method for producing polycycloolefins using a Group-X metal catalyst.

In this polymerization, it has been hitherto known that different catalysts show different controllability of the stereoregularity (atactic, erythro-disyndiotactic, erythro-diisotactic, etc.), regiochemistry of addition polymerization (2,3-addition/2,7-addition), and molecular weight in bicyclo[2.2.1]hept-2-ene polymer generated. For example, it is reported that norbornene polymers prepared by polymerization using a zirconium-based metallocene catalyst are infusible and insoluble in common solvents (Non-Patent Document 2).

Further, it is reported that addition polymers of norbornene prepared by polymerization using a nickel-based catalyst exhibit good solubility in hydrocarbon solvents such as cyclohexane, whereas norbornene polymers prepared by polymerization using a palladium-based catalyst, even lower-molecular-weight polymers, are soluble only in some halogenated aromatic solvents such as hot chlorobenzene and almost insoluble in common hydrocarbon solvents such as toluene and cyclohexane (For example, Non-Patent Document 2 and Non-Patent Document 3). It is also reported that the norbornene addition polymer obtained by polymerization using a palladium-based catalyst has high stereoregularity and regiochemistry of almost exclusive 2,3-addition (Non-Patent Document 4 and Non-Patent Document 5). Moreover, in the polymerization with a palladium-based catalyst, when some catalyst components are used, the molecular weight of the polymer is difficult to control, and the resulting norbornene polymer has an ultrahigh molecular weight and is insoluble in common solvents. Therefore, such a polymer has difficulty in forming process by solution-casting, and even if a film or sheet can be formed, it is insufficient in smoothness or transparency.

Meanwhile, bicyclo[2.2.1]hept-2-ene polymers prepared by polymerization using a nickel-based catalyst are soluble in hydrocarbon solvents and can be formed by casting, but the formed body is inferior in toughness and brittle.

As mentioned above, for bicyclo[2.2.1]hept-2-ene polymers, thermal melt-forming was impossible because of their extremely high glass transition temperature, and forming by casting was also difficult because of their low solubility. Moreover, films and sheets formed therefrom, if obtained, were inferior in smoothness, transparency, toughness, or the like.

Consequently, as a strategy of improving the transparency and toughness of bicyclo[2.2.1]hept-2-ene polymers, there has been proposed an addition (co)polymer obtained by using, as a monomer, a bicyclo[2.2.1]hept-2-ene derivative having an alkyl group as a substituent (hereinafter, also called “alkyl-substituted bicyclo[2.2.1]hept-2-ene”). Findings on said addition copolymer such as excellent optical properties are described, for example, in Patent Document 2, Patent Document 3, and Patent Document 4.

Alkyl-substituted bicyclo[2.2.1]hept-2-enes described above, alkylsilyl-substituted bicyclo[2.2.1]hept-2-enes, and the like are generally synthesized by Diels-Alder reaction of cyclopentadiene with an α-olefin or Diels-Alder reaction of cyclopentadiene with an alkylsilyl-substituted α-olefin. The alkyl-substituted bicyclo[2.2.1]hept-2-ene thus obtained includes stereoisomeric endo- and exo-forms and, in general, is an endo-rich mixture with a molar ratio of endo/exo in the range of 60/40 to 95/5. It is reported that, in addition-polymerization of this mixture using a palladium catalyst, the polymerization rate of the exo-isomer is higher than that of the endo-isomer (Non-Patent Document 6).

Non-Patent Document 7 reports a method for isomerizing endo-dicyclopentadiene to exo-dicyclopentadiene, while Patent Document 5 reports a method of synthesizing exo-alkyl-substituted bicyclo[2.2.1]hept-2-enes through a multistep pathway.

Patent Document 1: U.S. Pat. No. 6,455,650

### Patent Document 2: Japanese Patent No. 3476466

### Patent Document 3: Japanese Patent Laid-Open Publication No. 2002-12624

### Patent Document 4: Japanese Patent No. 3534127

Patent Document 5: U.S. Pat. No. 6,350,832
Non-Patent Document 1: Macromol. Rapid Commun., Vol. 22, 479-492 (2001)
Non-Patent Document 2: Makromol. Chem. Macromol. Symp., Vol. 47, 831 (1991)
Non-Patent Document 3: Macromol. Rapid Commun., Vol. 12, 255 (1991)
Non-Patent Document 4: Makromol. Chem. Macromol. Symp., 133, 1-10 (1998)
Non-Patent Document 5: J. Polymer Sci. Part B, Vol. 41, 2185-2199 (2003)

### Non-Patent Document 6: Polymer Preprint, Vol. 44, No. 2, 681 (2003)

### Non-Patent Document 7: Synthesis, 105 (1975)

### DISCLOSURE OF THE INVENTION

### Problems to be Solved by the Invention

The results of the present inventors' study revealed that, in the addition polymerization of an alkyl-substituted bicyclo[2.2.1]hept-2-ene or alkylsilyl-substituted bicyclo[2.2.1]hept-2-ene, the polymerization behavior and properties of the polymer generated greatly vary depending on a catalyst used, similarly to the addition polymerization of norbornene.

For example, when a mixture of endo- and exo-alkyl-substituted bicyclo[2.2.1]hept-2-ene is addition-polymerized using a nickel-based catalyst, these isomers showed almost no difference in reactivity, a homogeneous polymer was obtained, and films and sheets obtained by forming the polymer were excellent in transparency. However, this polymer was much inferior to the polymer obtained using a palladium-based catalyst in mechanical strength and toughness.

On the other hand, the studies of the present inventors revealed that the use of a palladium-based catalyst provides a polymer superior to the polymer produced using a nickel catalyst in mechanical strength, elongation, toughness, and the like. However, since the exo-isomer in the system disappears at the early or middle stage of the polymerization because of the lower reactivity of the endo-isomer, endo-rich polymer is generated particularly at the later stage of the polymerization, resulting in unevenness of endo/exo ratio in the polymer obtained. Further, the lower solubility of endo-rich polymer in hydrocarbon solvents causes a problem that the polymerization solution becomes opaque, ultimately resulting in opaqueness of films and sheets formed from the isolated polymer. If the polymerization were stopped at a low conversion, although the transparency of films and sheets formed could be improved, a large amount of remaining unreacted monomers would cause economical disadvantage and also a problematic complexity in the production process because of operations required to remove such unreacted monomers.

Measures for solving such problems include a technique of using an exo-rich alkyl- or alkylsilyl-substituted bicyclo[2.2.1]hept-2-ene. As a method for increasing the ratio of the exo-isomer in alkyl- or alkyl-substituted bicyclo[2.2.1]hept-2-enes, for example, isomerization of endo-dicyclopentadiene to exo-dicyclopentadiene is reported (Non-Patent Document 7). However, according to the experimental results of the present inventors, for example, when an alkyl-substituted bicyclo[2.2.1]hept-2-ene is isomerized by this method, the upper limit of the exo-content after isomerization is approximately 50% and hence the above problems are not solved yet. A method of multistep synthesis of exo-alkyl-substituted bicyclo[2.2.1]hept-2-enes is also reported, but this is industrially unrealistic (for example, Patent Document 5). Furthermore, since there is almost no difference in the boiling point between endo- and exo-isomers of alkyl- or alkylsilyl-substituted bicyclo[2.2.1]hept-2-enes, it is difficult to completely separate them by distillation.

Japanese Patent No. 3534127 (Patent Document 4) discloses an addition copolymer that contains a repeating unit derived from alkyl-substituted bicyclo[2.2.1]hept-2-ene wherein the alkyl substituent has 5 or more carbon atoms, the copolymer being synthesized in the presence of a palladium-based catalyst. However, since Patent Document 4 aims at providing an addition copolymer with a glass transition temperature low enough to be formed by melting, the addition copolymer described therein is not suitable for uses where heat resistance largely exceeding 200° C. is required.

U.S. Pat. No. 6,455,650 (Patent Document 1) discloses a method for producing polycycloolefins using a Group-X metal-based catalyst, and Examples thereof describe a large number of copolymerization reactions of mainly C₄₋₁₀ alkyl-substituted norbornene-type compounds with alkoxysilyl-containing norbornenes. However, since the introduction of many alkoxysilyl groups increases the water absorbency of the copolymer obtained, the obtained copolymer is not suitable for uses where low water absorbency is required.

Furthermore, neither Patent Document 1 nor Patent Document 4 points out influences of the difference in reactivity between the endo- and exo-isomers on the optical transparency and mechanical strength of a copolymer generated, and these documents propose no measures for improving these properties of the copolymer either.

In order to solve the above problems, the present invention has an object to provide a method for producing a cyclic olefin addition copolymer in which the molecular weight can be controlled with a molecular weight modifier even in addition copolymerization of a monomer composition that is a mixture of endo- and exo-isomers, particularly an endo-rich mixture, of cyclic olefins having a substituent selected from alkyl groups, alkylsilyl groups, and alkylsilylmethyl groups, the method providing, even at high conversion, a copolymer that is excellent in transparency, heat resistance, low water absorbency, mechanical strength, smoothness, and toughness when formed into sheet, film, or the like. The invention also has an object to provide a cyclic olefin addition copolymer excellent in the above properties and use thereof.

### Means to Solve the Problems

The method for producing a cyclic olefin addition copolymer of the present invention comprises addition-copolymerizing a monomer composition containing

(1) 5 to 80 mol % of a cyclic olefin having a substituent selected from alkyl groups, alkylsilyl groups, and alkylsilylmethyl groups represented by formula (1) below and
(2) 20 to 95 mol % of a cyclic olefin represented by formula (2) below (provided that the total of monomers in said monomer composition is 100 mol %)
in the presence of a palladium-based multicomponent catalyst containing
(i) a palladium compound selected from the group consisting of organic acid salts of palladium, β-diketone complexes of palladium, complexes having a ligand capable of coordinating to palladium through a phosphorous atom therein, and palladium complexes coordinated by a carbon-carbon double bond,
(ii) a phosphorus compound selected from the group consisting of phosphines that contain (a) substituent(s) selected from the group consisting of C₃₋₁₅ alkyl groups, C₃₋₁₅ cycloalkyl groups, and C₆₋₁₅ aryl groups and have a cone angle (0 in deg) of 170 to 2200, phosphonium salts derived from said phosphines, and complexes of said phosphines with organoaluminum compounds, and
(iii) an ionic boron compound or an ionic aluminum compound.

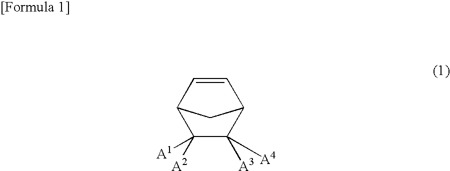

### (In formula (1), one of A¹ to A⁴ is a C₄₋₅ alkyl group, trimethylsilyl group, or trimethylsilylmethyl group; and the others each independently are a hydrogen atom, halogen atom, or methyl group.)

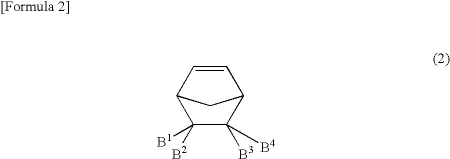

### (In formula (2), B¹ to B⁴ each independently are a hydrogen atom, methyl group, or halogen atom.)

The above production method preferably contains a step of starting polymerization using 20 to 95 wt % of the total amount of cyclic olefin (2) to be used and a step of further feeding the remaining part of cyclic olefin (2) during the polymerization.

The cyclic olefin addition copolymer of the present invention contains 5 to 80 mol % of structural units represented by formula (3) below and 20 to 95 mol % of structural units represented by formula (4) (provided that the total of the structural units in said copolymer is 100 mol %), and a 100-μm thick film formed from said copolymer has a light transmittance of 85% or more at a wavelength of 400 nm.

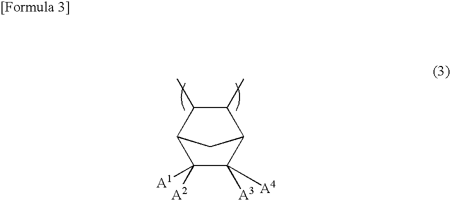

### (In formula (3), one of A¹ to A⁴ is a C₄₋₅ alkyl group, trimethylsilyl group, or trimethylsilylmethyl group; and the others each independently are a hydrogen atom, halogen atom, or methyl group.)

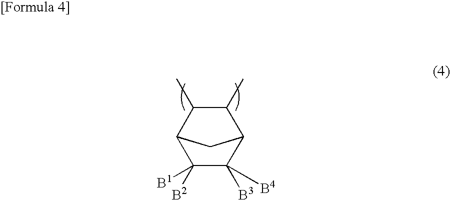

### (In formula (4), B¹ to B⁴ each independently are a hydrogen atom, methyl group, or halogen atom.)

The cyclic olefin addition copolymer can be preferably produced by the above production method.

The film or sheet of the present invention is formed from the above cyclic olefin addition copolymer.

### EFFECTS OF THE INVENTION

According to the present invention, there may be obtained a cyclic olefin addition copolymer whose molecular weight can be controlled with a molecular weight modifier even when prepared by addition-copolymerization of a monomer composition that is a mixture of endo- and exo-isomers, particularly such an endo-rich mixture that, for example, the molar ratio of endo:exo is in the range of 60:40 to 95:5 (provided that the total of both isomers is 100), containing (an) alkyl- or alkylsilyl-substituted cyclic olefin(s). The cyclic olefin addition copolymer, even when obtained at high polymerization conversion, is excellent in transparency, heat resistance, low water absorbency, mechanical strength, smoothness, and toughness when formed into sheet, film, or the like. The cyclic olefin addition copolymer can be formed by solution-casting using an alicyclic hydrocarbon solvent or aromatic hydrocarbon solvent.

### BRIEF DESCRIPTION OF THE DRAWINGS

FIG. 1 shows the ¹H-NMR spectrum of copolymerA obtained in Example 1.

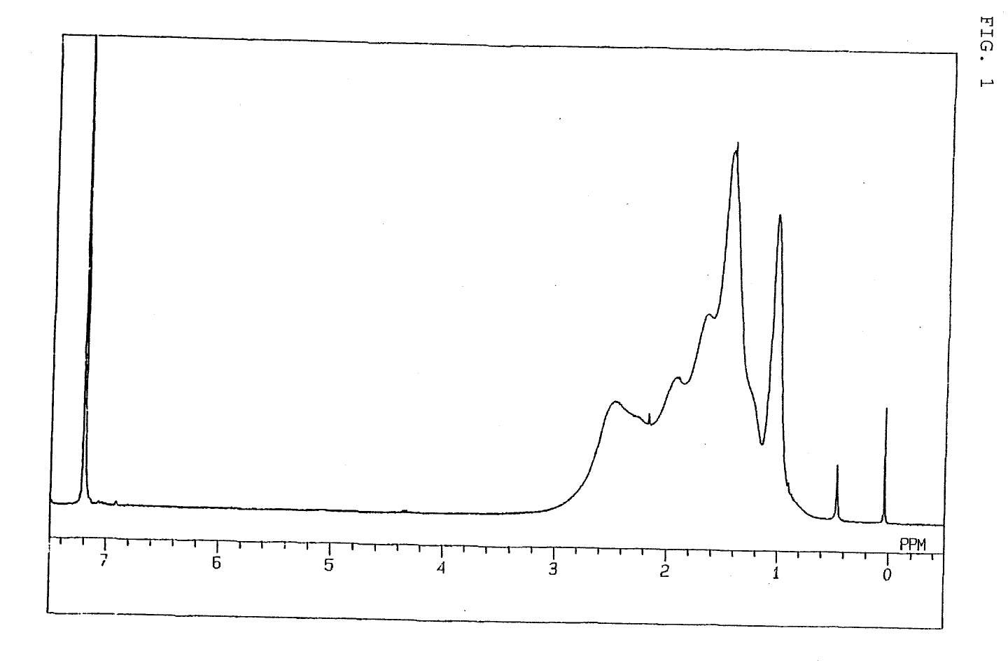

FIG. 2 shows the ¹H-NMR spectrum of copolymer B obtained in Example 2.

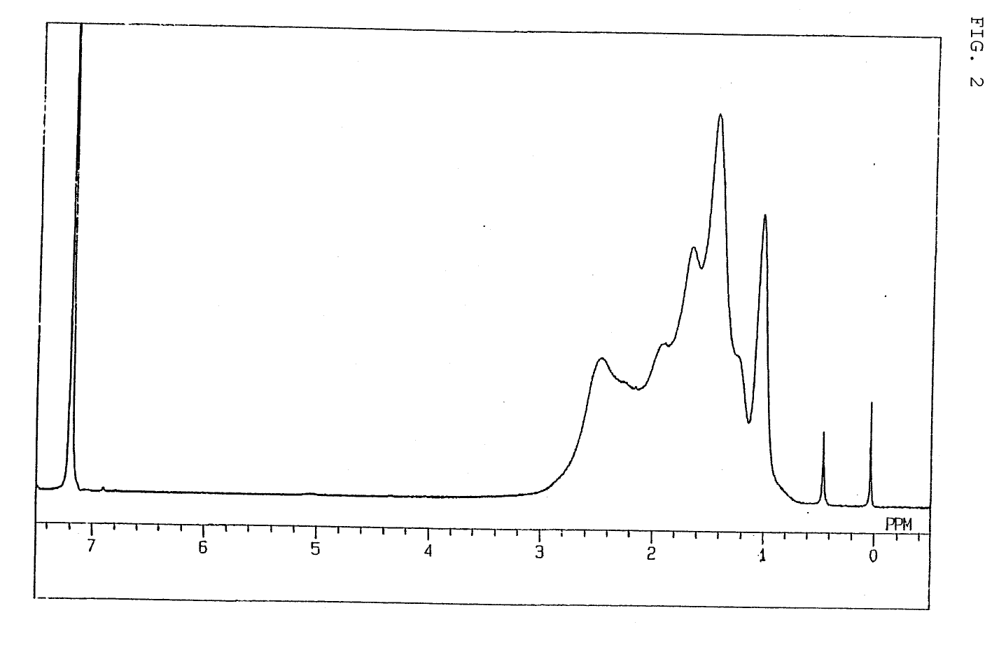

### BEST MODE FOR CARRYING OUT THE INVENTION

Hereinafter, the present invention will be specifically explained.

### [Method for Producing Cyclic Olefin Addition Copolymer]

### <Monomer Composition>

In the method of producing a cyclic olefin addition copolymer of the present invention, the monomer composition to be polymerized contains

(1) 5 to 80 mol % of a cyclic olefin (hereinafter also called “specific monomer (1)”) having a substituent selected from alkyl groups, the alkylsilyl group, and the alkylsilylmethyl group represented by formula (1) below, and
(2) 20 to 95 mol % of a cyclic olefin (hereinafter also called “specific monomer (2)”) represented by formula (2) below (provided that the total of monomers in said monomer composition is 100 mol %).

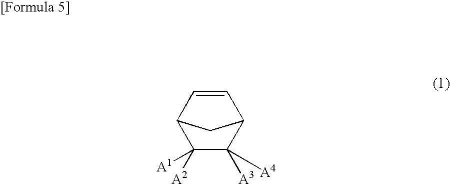

### (In formula (1), one of A¹ to A⁴ is a C₄₋₅ alkyl group, trimethylsilyl group, or trimethylsilylmethyl group; and the others each independently are a hydrogen atom, halogen atom, or methyl group.)

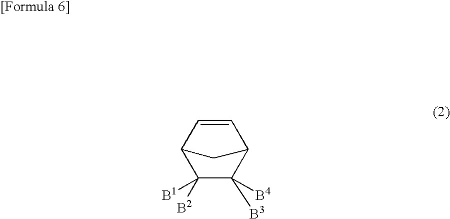

### (In formula (2), B¹ to B⁴ each independently are a hydrogen atom, methyl group, or halogen atom.)

The specific monomer (1) includes, but not particularly limited to, for example, 5-butylbicyclo[2.2.1]hept-2-ene, 5-t-butylbicyclo[2.2.1]hept-2-ene, 5-isobutylbicyclo[2.2.1]hept-2-ene, 5-pentylbicyclo[2.2.1]hept-2-ene, 5-butyl-6-methylbicyclo[2.2.1]hept-2-ene, 5-chloro-6-butylbicyclo[2.2.1]hept-2-ene, 5-fluoro-6-butylbicyclo[2.2.1]hept-2-ene, 5-trimethylsilylbicyclo[2.2.1]hept-2-ene, 5-trimethylsilylmethylbicyclo[2.2.1]hept-2-ene, and the like. These may be used alone or in combination of two or more.

Among these, preferable are compounds in which one of A¹ to A⁴ is a C₄₋₅ alkyl group and all the others are hydrogen atoms in formula (1), that is, 5-butylbicyclo[2.2.1]hept-2-ene, 5-t-butylbicyclo[2.2.1]hept-2-ene, 5-isobutylbicyclo[2.2.1]hept-2-ene and 5-pentylbicyclo[2.2.1]hept-2-ene. Also preferable is a compound in which one of A¹ to A⁴ is a trimethylsilyl group and all the others are hydrogen atoms in formula (1), that is, 5-trimethylsilylbicyclo[2.2.1]hept-2-ene. Especially preferable are 5-butylbicyclo[2.2.1]hept-2-ene and 5-trimethylsilylbicyclo[2.2.1]hept-2-ene in terms of polymerization reactivity and mechanical strength and toughness of films or sheets formed from the resultant addition polymer.

In contrast, when a cyclic olefin having an alkyl group with 3 or less carbon atoms in formula (1) is used in place of specific monomer (1), the resulting film or sheet is insufficient in toughness and brittle. In addition, when a cyclic olefin having an alkyl group with 6 or more carbon atoms is used in the same way, the resulting film or sheet may deteriorate in mechanical strength or heat resistance, and moreover, the high boiling point of said cyclic olefin causes difficulty in removing the monomer remained after polymerization by heating.

Specific monomer (1) can be synthesized, for example, by Diels-Alder reaction of cyclopentadiene with an olefin represented by formula (5) below.

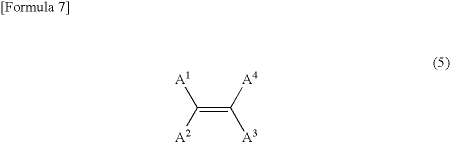

### (In formula (5), one of A¹ to A⁴ is a C₄₋₅ alkyl group, trimethylsilyl group, or trimethylsilylmethyl group; and the others each independently are a hydrogen atom, halogen atom, or methyl group.)

Specific monomer (1) synthesized by Diels-Alder reaction includes stereoisomeric endo- and exo-forms and is usually an endo-rich mixture in which the molar ratio of the endo-isomer to the exo-isomer (endo:exo) is in the range of 60:40 to 95:5 (provided that the total of both isomers is 100). In the present invention, the synthetic method of specific monomer (1) is not particularly limited. However, when it is synthesized by Diels-Alder reaction and the obtained mixture is used without additional steps such as separation or isomerization of the stereoisomers, such method is economical and has an advantage that the source materials are easily available.

In the present invention, by adjusting the ratio of specific monomer (1) in the monomer composition to be polymerized, it is possible to control the balance between breaking strength and elongation, hardness, elastic modulus, and the like of films or sheets formed from the resulting cyclic olefin copolymer according to purposes of their use. The ratio of specific monomer (1) is 5 to 80 mol %, preferably 10 to 80 mol %, and more preferably 20 to 70 mol % in 100 mol % of all monomers to be polymerized in the present invention. If the ratio of specific monomer (1) is less than 5 mol %, the resulting film or sheet may be inferior in transparency, smoothness, or toughness, while if the ratio of specific monomer (1) exceeds 80 mol %, the resulting film or sheet may be inferior in transparency or mechanical strength and may be unsuitable for uses where heat resistance is required because the resulting copolymer has a low glass transition temperature.

Specific monomer (2) includes, but not particularly limited to, for example, bicyclo[2.2.1]hept-2-ene, 5-methylbicyclo[2.2.1]hept-2-ene, 5,5-dimethylbicyclo[2.2.1]hept-2-ene, 5,6-dimethylbicyclo[2.2.1]hept-2-ene, 5-chlorobicyclo[2.2.1]hept-2-ene, 5-fluorobicyclo[2.2.1]hept-2-ene, and the like. These may be used alone or in combination of two or more. Among these, bicyclo[2.2.1]hept-2-ene is preferably used because the resulting addition copolymer is especially excellent in mechanical strength. The ratio of specific monomer (2) is 20 to 95 mol %, preferably 20 to 90 mol %, and further preferably 30 to 80 mol % in 100 mol % of the all monomers to be polymerized in the present invention. If the ratio of specific monomer (2) is less than 20 mol % in all monomers, the resulting film or sheet may be inferior in transparency or mechanical strength in some cases, while if the ratio of specific monomer (2) exceeds 95 mol %, the resulting film or sheet may deteriorate in transparency, smoothness, or toughness.

In the present invention, the monomer composition to be polymerized may further contain a cyclic olefin having a functional group such as ester, acid anhydride, carboximide, and hydrolysable silyl groups as a side-chain substituent, in addition to specific monomer (1) and specific monomer (2), for the purpose of imparting adhesiveness to the resulting copolymer or introducing a crosslinkable portion, in an amount of 10 mol % or less in 100 mol % of the total monomers. Specific examples of such cyclic olefins include, but not limited to, methyl bicyclo[2.2.1]hept-5-ene-2-carboxylate, methyl 2-methylbicyclo[2.2.1]hept-5-ene-2-carboxylate, ethyl bicyclo[2.2.1]hept-5-ene-2-carboxylate, ethyl 2-methylbicyclo[2.2.1]hept-5-ene-2-carboxylate, t-butyl bicyclo[2.2.1]hept-5-ene-2-carboxylate, t-butyl 2-methylbicyclo[2.2.1]hept-5-ene-2-carboxylate, methyl tetracyclo[6.2.1.1^{3,6}.0^{2,7}]dodec-9-ene-4-carboxylate, ethyl tetracyclo[6.2.1.1^{3,6}.0^{2,7}]dodec-9-ene-4-carboxylate, methyl 4-methyltetracyclo[6.2.1.1^{3,6}.0^{2,7}]dodec-9-ene-4-carboxylate, methyl 4-ethyltetracyclo[6.2.1.1^{3,6}.0^{2,7}]dodec-9-ene-4-carboxylate, ethyl 4-methyltetracyclo[6.2.1.1^{3,6}.0^{2,7}]dodec-9-ene-4-carboxylate, propyl tetracyclo[6.2.1.1^{3,6}.0^{2,7}]dodec-9-ene-4-carboxylate, dimethyl tetracyclo[6.2.1.1^{3,6}.0^{2,7}]dodec-9-ene-4,5-dicarboxylate, 4-methoxycarbonyl-5-t-butoxycarbonyltetracyclo[6.2.1.1^{3,6}.0^{2,7}]dodec-9-ene, N-cyclohexylbicyclo[2.2.1]hept-5-ene-2,3-carboximide, N-cyclohexyltetracyclo[6.2.1.1^{3,6}.0^{2,7}]dodec-9-ene-4,5-carboximide, N-ethyltetracyclo[6.2.1.1^{3,6}.0^{2,7}]dodec-9-ene-4,5-carboximide 2,2-(N-cyclohexylsuccinimid-2-yl)bicyclo[2.2.1]hept-5-ene, 4,4-(N-cyclohexylsuccinimid-2-yl)tetracyclo[6.2.1.1^{3,6}.0^{2,7}]dodec-9-ene, tetracyclo[6.2.1.1^{3,6}.0^{2,7}]dodec-9-ene-4,5-dicarboxylic anhydride, 5-trimethoxysilylbicyclo[2.2.1]hept-2-ene, 5-triethoxysilylbicyclo[2.2.1]hept-2-ene, 5-chlorodiethoxysilylbicyclo[2.2.1]hept-2-ene, 4-trimethoxysilyltetracyclo[6.2.1.1^{3,6}.0^{2,7}]dodec-9-ene, 4-triethoxysilyltetracyclo[6.2.1.1^{3,6}.0^{2,7}]dodec-9-ene, 5-methyldimethoxysilylbicyclo[2.2.1]hept-2-ene, 4-methyldiethoxysilyltetracyclo[6.2.1.1^{3,6}.0^{2,7}]dodec-9-ene, and the like. If the ratio of these cyclic olefins exceeds 10 mol %, a film or sheet formed from the resulting copolymer sometimes exhibits an increase in water absorbency and deteriorates in transparency or mechanical strength, and further the polymerization reactivity in the addition polymerization may significantly decrease.

In the present invention, the monomer composition to be polymerized may also contain a tricycloolefin such as tricyclo[5.2.1.0^{2,6}]dec-8-ene or tricyclo[5.2.1.0^{2,6}]deca-3,8-diene or a tetracycloolefin such as tetracyclo[6.2.1.1^{3,6}.0^{2,7}]dodec-4-ene, 9-methyltetracyclo[6.2.1.1^{3,6}.0^{2,7}]dodec-4-ene, and 9-ethyltetracyclo[6.2.1.1^{3,6}.0^{2,7}]dodec-4-ene in addition to specific monomer (1) and specific monomer (2) for the purpose of improving the toughness of the resulting copolymer or adjusting the glass transition temperature of said copolymer. Such a tricycloolefin or tetracycloolefin may be used in a range of not more than 40 mol % in 100 mol % of the total with specific monomer (1) and specific monomer (2). If more than 40 mol % of tricycloolefin and tetracycloolefin are used, a film or sheet obtained from the copolymer may deteriorate in transparency.

### <Palladium-Based Multicomponent Catalyst>

In the method for producing a cyclic olefin addition copolymer of the present invention, there is used a palladium-based multicomponent catalyst containing

(i) a palladium compound selected from the group consisting of organic acid salts of palladium, β-diketone complexes of palladium, complexes having a ligand capable of coordinating to palladium through a phosphorous atom therein, and palladium complexes coordinated by a carbon-carbon double bond,
(ii) a phosphorus compound selected from the group consisting of phosphines that contain (a) substituent (s) selected from the group consisting of C₃₋₁₅ alkyl groups, C₃₋₁₅ cycloalkyl groups, C₆₋₁₅ aryl groups and have a cone angle (0 in deg) of 170 to 200°, phosphonium salts derived from said phosphines, and complexes of said phosphines with organoaluminum compounds, and
(iii) an ionic boron compound or an ionic aluminum compound.

In palladium compound (i), the organic acid salt of palladium includes, for example, carboxylates such as acetate, propionate, maleate, fumarate, butyrate, adipate, 2-ethylhexanoate, naphthenate, oleate, dodecanoate, neodecanoate, 1,2-cyclohexanedicarboxylate, 5-norbornene-2-carboxylate, benzoate, phthalate, naphthoate, and trifluoroacetate; organic sulfonates such as dodecylbenzenesulfonate, p-toluenesulfonate, and trifluoromethanesulfonate; salts of organic phosphoric acid or salts of organic phosphorous acid such as octylphosphate, phenylphosphate, salt of dioctyl phosphate, and salt of dibutyl phosphate; and the like.

Examples of the β-diketone complex of palladium include bis(acetylacetonato)palladium, bis(hexafluoroacetylacetonato)palladium, bis(ethylacetoacetate)palladium, bis(phenylacetoacetate)palladium, and the like.

The complex containing a ligand capable of coordinating to palladium through a phosphorous atom includes (triphenylphosphine)palladium diacetate, (tricyclohexylphosphine)palladium diacetate, dichlorobis(triphenylphosphine)palladium, dichlorobis(tricyclohexylphosphine)palladium, dichlorobis[tri(m-tolyl)phosphine]palladium, and the like.

The palladium complex coordinated by a carbon-carbon double bond includes diene complexes such as (1,5-cyclooctadiene)palladium dichloride, (methyl)(1,5-cyclooctadiene)palladium chloride, [(η³-allyl)(1,5-cyclooctadiene)palladium]hexafluorophosphate, [(η³-crotyl)(1,5-cyclooctadiene)palladium]hexafluorophosphate, and [6-methoxynorbornen-2-yl-5-palladium(cyclooctadiene)]hexafluorophosphate, and the like.

Among these palladium compounds, preferably used are organic acid salts of palladium and β-diketone complexes of palladium. These palladium compounds may be used alone or in combination of two or more.

In phosphorus compound (II), the cone angle (0 deg) of a phosphine is a conical angle formed by a metal atom to which a phosphorus atom coordinates and three substituents bonding to the phosphorus atom wherein the metal atom is located at the top and the bonding distance between the phosphorus atom and the metal atom is assumed to be 2.28 Å, as detailed in Chem. Rev. Vol. 77, 313 (1977). Specific example of the phosphine having a cone angle (0 deg) of 170 to 2000 used in the present invention include tricyclohexylphosphine, di-t-butylphenylphosphine, trineopentylphosphine, tri(t-butyl)phosphine, tri(pentafluorophenyl)phosphine, tri(o-tolyl)phosphine, and the like. They also include di-t-butyl-2-biphenylylphosphine, di-t-butyl-2′-dimethylamino-2-biphenylylphosphine, dicyclohexyl-2-biphenylylphosphine, dicyclohexyl-2′-isopropyl-2-biphenylylphosphine, and the like.

In phosphorus compound (II), the phosphonium salt is a phosphonium salt derived from the above phosphine, and more preferably a phosphonium salt formed from the above phosphine serving as an electron donor and a Brønsted acid selected from super-strong acids, sulfonic acids, carboxylic acids, and the like. Specific examples of such phosphonium salts include tricyclohexylphosphonium tetrakis(pentafluorophenyl)borate, tri-t-butylphosphonium tetrakis(pentafluorophenyl)borate, tricyclohexylphosphonium tetrafluoroborate, tricyclohexylphosphonium octanoate, tricyclohexylphosphonium acetate, tricyclohexylphosphonium trifluoromethanesulfonate, tri-t-butylphosphonium trifluoromethanesulfonate, tricyclohexylphosphonium p-toluenesulfonate, tricyclohexylphosphonium hexafluoroacetylacetonate, tricyclohexylphosphonium hexafluoroantimonate, tricyclohexylphosphonium hexafluorophosphonate, and the like.

In phosphorus compound (II), the complex of a phosphine and an organoaluminum compound is a complex formed from the above phosphine serving as an electron donor and an organoaluminum compound serving as an electron acceptor. The organoaluminum compound is preferably a trialkylaluminum or dialkylaluminum, and specific examples thereof include trimethylaluminum, triethylaluminum, triisobutylaluminum, diisobutylaluminum hydride, and the like. The complex formed from the above phosphine and the organoaluminum compound includes tricyclohexylphosphine-trimethylaluminum complex, tricyclohexylphosphine-triethylaluminum complex, tricyclohexylphosphine-triisobutylaluminum complex, tricyclohexylphosphine-diisobutylaluminum hydride complex, tri(pentafluorophenyl)phosphine-triethylaluminum complex, tri(o-tolyl)phosphine-triethylaluminum complex, and the like.

These phosphorus compounds may be used alone or in combination of two or more.

As ionic boron compound or ionic aluminum compound (iii), there is used, for example, an ionic compound represented by

[L]⁺[CA]⁻

(wherein [L]⁺ represents a Lewis acid cation, ammonium cation, or metal cation, and [CA]⁻ represents a non-coordinating or weakly coordinating anion selected from B(C₆H₅)₄⁻, B(C₆F₅)₄⁻, B[C₆H₃(CF₃)₂]₄⁻, Al(C₆F₅)₄⁻, and Al[C₆H₃(CF₃)₂]₄⁻.)

Specific examples of the ionic boron compound include, but not limited to, triphenylcarbenium tetrakis(pentafluorophenyl)borate, triphenylcarbenium tetrakis[3,5-bis(trifluoromethyl)phenyl]borate, triphenylcarbenium tetrakis(2,4,6-trifluorophenyl)borate, triphenylcarbenium tetraphenylborate, tributylammonium tetrakis(pentafluorophenyl)borate, N,N-dimethylanilinium tetrakis(pentafluorophenyl)borate, N,N-diethylanilinium tetrakis(pentafluorophenyl)borate, N,N-diphenylanilinium tetrakis(pentafluorophenyl)borate, lithium tetrakis(pentafluorophenyl)borate, and the like. Specific examples of the ionic aluminum compound include, but not limited to, triphenylcarbenium tetrakis(pentafluorophenyl) aluminate, triphenylcarbenium tetrakis[3,5-bis(trifluoromethyl)phenyl]aluminate, triphenylcarbenium tetrakis(2,4,6-trifluorophenyl)aluminate, and the like. These ionic boron compounds or ionic aluminum compounds may be used alone or in combination of two or more.

The palladium-based multicomponent catalyst used in the present invention may further contain an organoaluminum compound (iv) as a catalyst component in addition to components (i) to (iii) for the purpose of increasing the catalytic activity or preventing the deactivation due to water or oxygen. Organoaluminum compound (iv) includes, for example, alkylalmoxanes such as methylalmoxane, ethylalmoxane, and butylalmoxane; trialkylaluminums such as trimethylaluminum, triethylaluminum, and triisobutylaluminum; dialkylaluminum hydrides such as diisobutylaluminum hydride; dialkylaluminum alkoxides such as diethylaluminum butoxide; dialkylaluminum halides such as diethylaluminum chloride and diethylaluminum fluoride; and the like.

In the palladium-based multicomponent catalyst used in the present invention, each of components (i) to (iv) is used in the following ratio.

(i) palladium compound: preferably 0.0002 to 0.1 millimole, more preferably 0.0005 to 0.01 millimole, in terms of palladium atom relative to 1 mole of monomers to be polymerized in the present invention;

(ii) phosphorus compound: preferably 0.2 to 3.0 times, more preferably 0.5 to 2.0 times, as molar ratio to palladium atom in palladium compound (i);

(iii) ionic boron compound or ionic aluminum compound: preferably 0.2 to 10 times, more preferably 0.5 to 2.0 times as molar ratio to palladium atom in palladium compound (i); and

(iv) organoaluminum compound: optional component, preferably 0 to 30 times, more preferably 0 to 20 times in terms of aluminum atom as molar ratio to palladium atom in palladium compound (i).

When components listed in (i) to (iii) and optionally a component listed in (iv) are appropriately used, the molecular weight of the resulting copolymer can be controlled using a molecular weight modifier, and further a cyclic olefin addition copolymer excellent in heat resistance, flexibility, and toughness can be obtained. Components (i) to (iii) and if needed, component (iv) may be added simultaneously or sequentially to a mixture of monomers to be polymerized in the present invention and a solvent. Part or all of the catalyst components may be added after contacted with each other in advance. Further, they may be contacted with a cyclic olefin such as 1,3-cyclohexadiene, 1,5-cyclooctadiene, and bicyclo[2.2.1]hepta-2,5-diene or a linear diene such as 1,3-butadiene and 1,4-pentadiene, followed by aging, and then added.

As polymerization catalysts for cyclic olefins, palladium-based single-component catalysts have been also known so far. Such palladium-based single-component catalysts include, for example, palladium compounds represented by

[(RCN)₄Pd][CA]₂

(wherein R represent a hydrocarbon group such as methyl, ethyl, isopropyl, t-butyl, phenyl, tolyl, naphthyl, cyclohexyl, and bicyclo[2.2.1]heptanyl; and CA represents a counter anion such as BF₄⁻, PF₆⁻, CF₃C(O)O⁻, and CF₃SO₃⁻), specifically tetrakis(acetonitrile)palladium tetrafluoroborate, tetrakis(propionitrile)palladium tetrafluoroborate, tetrakis(benzonitrile)palladium tetrafluoroborate, and the like. However, since these catalysts are required in large quantities due to the low polymerization activity, the resulting copolymer may deteriorate in hue or transparency. Further, cast-forming of the copolymer may be difficult because it is insoluble in hydrocarbon solvents, the molecular weight control may be difficult, and the copolymer may be inferior in heat resistance. For these reasons, these catalysts are not desirable for use.

### <Addition Polymerization Method>

The production method of the present invention can provide a cyclic olefin addition polymer that is suitable for producing films or sheets excellent transparency, heat resistance, low water absorbency, mechanical strength, smoothness, and toughness even when the polymerization conversion is high based on the feature of copolymerizing specific monomer (1) and specific monomer (2) in the presence of the specific palladium-based multicomponent catalyst.

In such addition polymerization, although the best method of feeding specific monomer (2) to a reactor depends on the composition of the desired addition copolymer or other parameters, a desirable method comprises the first step of charging into the reactor 20 to 95 wt %, preferably 40 to 92 wt % of specific monomer (2) to start the polymerization and the second step of feeding the residual part of specific monomer (2) to the reactor during the polymerization. In the second step, specific monomer (2) may be fed at a time, but desirably fed by two or more portions or continuously. This method is effective to prevent the occurrence of significant unevenness of composition in the resultant addition copolymer. Namely, since the ratio of the endo-isomer of specific monomer (1) to the total monomers can be controlled within a suitable range throughout the polymerization process, this method can effectively prevent generation of endo-rich polymer in the later stage of the polymerization due to the lower polymerization reactivity of the endo-isomer, and hence the occurrence of significant unevenness of composition in the resultant copolymer. Moreover, this method can prevent generation a component having a high endo-content and hence low solubility to hydrocarbon solvents in the late stage of the polymerization. As a result, there can be obtained a cyclic olefin addition copolymer that exhibits more excellent in transparency when formed into films or sheets.

The optimum amount and timing of introduction of specific monomer (1) and specific monomer (2) may be selected based on the ratio of reactivities of these monomers determined as reactivity ratio (r1 and r2) according to the Fineman-Ross method or the like. The monomer composition in the polymerization system may be monitored by sampling the polymerization solution in a convenient manner and analyzing the concentration of each unreacted monomer, the conversion of each monomer, the copolymer composition determined by ¹H-NMR, and the like.

In the polymerization system, the fraction of the endo-isomer of specific monomer (1) in the total monomers is preferably 5 to 85 mol %, more preferably 10 to 85 mol %, and further preferably 15 to 80 mol %. If the endo-fraction is higher than these ranges, the film or sheet formed is opaque because a component having a high endo-content and hence low solubility is generated particularly in the later stage of the polymerization, or because the endo-content is significantly uneven in the resulting copolymer.

In the production method of the present invention, the addition polymerization is typically performed under an atmosphere of nitrogen or argon. The polymerization system may be batch or continuous. For example, a tubular continuous reactor equipped with a suitable monomer feed port may be used. The polymerization temperature is set in the range of typically 0 to 150° C., preferably 50 to 150° C., and more preferably 60 to 120° C.

The solvent used in the polymerization includes, but not limited to, alicyclic hydrocarbons such as cyclohexane, cyclopentane, and methylcyclopentane; aliphatic hydrocarbons such as hexane, heptane, and octane; aromatic hydrocarbons such as toluene, benzene, xylene, and mesitylene; halogenated hydrocarbons such as dichloromethane, 1,2-dichloroethylene, 1,1-dichloroethylene, tetrachloroethylene, chlorobenzene, and dichlorobenzene; and the like, which may be used alone or in combination of two or more. Among these, preferable solvents are alicyclic hydrocarbons and aromatic hydrocarbons. These solvents may be used typically in a range of 50 to 2,000 parts by weight relative to 100 parts by weight of the total monomers to be polymerized in the present invention.

In the production method of an addition copolymer relating to the present invention, the molecular weight of the resulting copolymer can be controlled as desired by performing the addition copolymerization in the presence of a molecular weight modifier, resulting in advantages such that the viscosity of a solution used in film- or sheet-formation by casting can be adjusted to be suitable. The molecular weight modifier used in the present invention includes, for example, α-olefins or substituted α-olefins such as ethylene, propylene, 1-butene, 1-hexene, 1-octene, trimethylvinylsilane, and trimethoxyvinylsilane; aromatic vinyl compounds such as styrene and α-methylstyrene; alcohols such as methanol, isopropanol, and t-butanol; silanes such as triethylsilane and tributylsilane; hydrogen; and the like. These molecular weight modifiers may be used in an amount of 0.0001 to 0.2-fold as molar ratio to the total monomers to be polymerized in the present invention. As the molecular weight modifier, there may be also used aluminum hydrides such as diisobutylaluminum hydride, borane-ether complexes, and the like. In this case, these molecular weight modifiers may be used in an amount of 0.1 to 1000-fold as molar ratio to palladium atom. These molecular weight modifiers may be used alone or in combination of two or more. Among these molecular weight modifiers, preferably used is an α-olefin or an aromatic vinyl compound.

When the resulting cyclic olefin addition copolymer contains olefinic unsaturated bonds, for example, when there is used, besides specific monomer (1) and specific monomer (2), another monomer having an olefinic unsaturated bond that is not involved in the polymerization such as tricyclo[5.2.1.0^{2,6}]deca-3,8-diene, it is preferred to hydrogenate said olefinic unsaturated bonds after the polymerization. The hydrogenation rate is preferably as high as possible, and it is typically not less than 90%, preferably not less than 95%, and more preferably not less than 99%. Any known hydrogenation method may be appropriately used herein without particular limitation. For example, the hydrogenation may be performed in an inert solvent in the presence of a hydrogenation catalyst under a hydrogen pressure of 0.5 to 17 MPa at a reaction temperature of 0 to 200° C.

In the method for producing a cyclic olefin addition copolymer of the present invention, the production process may contain a step for removing a catalyst component used for the addition copolymerization and a hydrogenation catalyst component when used. The method for this step is not particularly limited and may be conveniently selected according to the catalyst used. There may be mentioned, for example, a method in which the catalyst component is separated from the reaction mixture after the polymerization by extracting with water, an alcohol, ketone, ester, or the like after adding a carboxylic acid such as formic acid, acetic acid, oxalic acid, lactic acid, glycolic acid, β-methyl-β-hydroxypropionic acid, and γ-hydroxybutyric acid, sodium salt of tris(sulfophenyl)phosphine, dipyridyl, quinoline, triethanolamine, dialkylethanolamine, ethylenediaminetetraacetate, or the like; a method of isolating the polymer by precipitation; a method of treating with kieselguhr, silica, alumina, activated charcoal, ion-exchange resin, or the like; a combination thereof; and the like. In the addition copolymer obtained by the production method of the present invention, the content of palladium atom derived from the residual catalyst is preferably not more than 5 ppm and more preferably not more than 2 ppm.

As the method for isolating the cyclic olefin addition copolymer obtained by the production method of the present invention, non-limiting examples include a method in which the polymer is precipitated by adding a poor solvent such as alcohols and ketones, followed by drying to obtain the polymer, a method in which the solvent is distilled off from the polymer solution with heating to obtain the polymer and the like.

Alternatively, the reaction solution containing the cyclic olefin addition copolymer may be directly subjected to the cast-forming step to form into film or sheet without isolation.

[Cyclic Olefin Addition Copolymer]

The cyclic olefin addition copolymer of the present invention is characterized in that it contains a structural units represented by formula (3) below and structural units represented by formula (4) below and that the light transmittance is not less than 85% at a wavelength of 400 nm when formed into a 100-μm thick film.

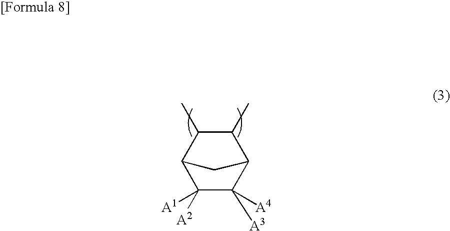

### (In formula (3), one of A¹ to A⁴ is a C₄₋₅ alkyl group, trimethylsilyl group, or trimethylsilylmethyl group; and the others each independently are a hydrogen atom, halogen atom, or methyl group.)

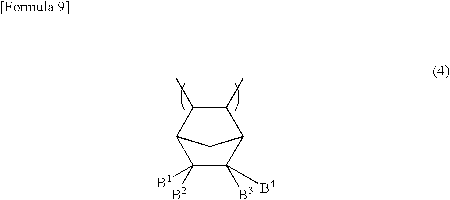

### (In formula (4), B¹ to B⁴ each independently are a hydrogen atom, methyl group, or halogen atom.)

In formula (3), one of A¹ to A⁴ is preferably a butyl or trimethylsilyl group, and the others are preferably hydrogen atoms.

In formula (4), all of B¹ to B⁴ are preferably hydrogen atoms.

Here, for the fractions of individual structural units comprising the cyclic olefin addition copolymer of the present invention, the structural units represented by formula (3) are in the range of 5 to 80 mol %, preferably 10 to 80 mol %, and more preferably 20 to 70 mol %, while the structural units represented by formula (4) are 20 to 95 mol %, preferably 20 to 90 mol %, and more preferably 30 to 80 mol %, provided that the total of all structural units is 100 mol %. If the fraction of the structural units represented by formula (3) is less than 5 mol %, a film or sheet obtained from the cyclic olefin addition copolymer may be inferior in transparency, smoothness, or toughness, whereas if the ratio of the structural units represented by formula (3) exceeds 80 mol %, the film or sheet obtained may be inferior in transparency or mechanical strength.

The cyclic olefin addition copolymer of the present invention is desirably a copolymer obtained by the production method of the present invention.

The cyclic olefin addition copolymer of the present invention typically has a number-average molecular weight (Mn) of 10,000 to 200,000 and a weight-average molecular weight (Mw) of 20,000 to 500,000 in terms of polystyrene. Preferably, its number-average molecular weight is 30,000 to 100,000 and its weight-average molecular weight is 50,000 to 300,000. If the number-average molecular weight of the cyclic olefin addition copolymer is less than 10,000, the film or sheet formed has poor mechanical strength and may be easily cracked in some cases. While, if its number-average molecular weight exceeds 200,000, the polymer solution composition may be too viscous to be easily formed into a film or sheet, and the film, even if formed, may be inferior in smoothness.

The glass transition temperature (Tg) of the cyclic olefin addition copolymer of the present invention is determined as a peak temperature in the temperature dependence of tan δ=E″/E′ calculated from a storage modulus (E′) and a loss modulus (E″) measured in dynamic viscoelasticity measurement. The glass transition temperature of the polymer is preferably 220° C. to 450° C. and more preferably 250 to 400° C. so as to avoid problems such as thermal deformation of the polymer in working processes where extremely high heat-resistance is required. The polymer having glass transition temperature less than 220° C. is not preferable because the poor heat-resistance may cause problems such as deformation in some working processes. On the other hand, if the glass transition temperature of the polymer exceeds 450° C., a film or sheet formed from the polymer is inferior in toughness and may be easily cracked in some cases. The glass transition temperature can be easily controlled by adjusting the ratio of structural units represented by formula (3) and formula (4) or selecting another monomer copolymerized with specific monomer (1) and specific monomer (2), for example, selecting a tricycloolefin, in the monomer composition.

The cyclic olefin addition copolymer of the present invention can be suitably used for optical materials because it exhibits excellent transparency when formed into a film or sheet. When said cyclic olefin addition copolymer is formed into a 100-μm thick film by an arbitrary method, the light transmittance of the film is not less than 85% and preferably not less than 88% at a wavelength of 400 nm.

The cyclic olefin addition copolymer of the present invention may be formed by a well-known method without particular limitation. Usable methods include casting, a method in which the cyclic olefin addition copolymer of the present invention is swollen with a solvent and then formed with an extruder while the solvent is evaporated, injection molding, blow molding, press molding, extruding molding, and the like. Among these, casting is preferable.

The production of a film or sheet by casting may be performed, for example, as follows. Firstly, there is prepared a cyclic olefin addition copolymer composition solution (hereinafter also called “polymer composition solution”) that contains the cyclic olefin addition copolymer of the present invention, a solvent, and optionally additives, such as acid generator, antioxidant, and filler, and has a solid content of 5 to 50 wt %, preferably 10 to 40 wt %, and more preferably 15 to 35 wt %. Next, this polymer composition solution is cast on a support such as heat-resistant material like polyethylene terephthalate, steel belt, flat plate or roll of metal foil or the like, silicon wafer, and glass plate by a method such as application, spin coat, and dipping using a bar coater, a T-die, a bar-equipped T-die, a doctor knife, a roll coater, a die coater, or the like. Thereafter, the polymer composition solution on the support is dried until the residual solvent decreases to 30 wt % or less at a temperature range of 10 to 100° C. and preferably 20 to 80° C., wherein the temperature may vary according to the type of solvent. Then, the film or sheet is peeled off from the support on which it is formed, and preferably further dried at a temperature range of 10 to 250° C.

When the cyclic olefin addition copolymer of the present invention has an acid-hydrolysable ester group or an alkoxysilyl group that can undergo acid-induced hydrolytic condensation, a film or sheet comprising a crosslinked cyclic olefin addition copolymer may be obtained by forming a film or sheet from a composition containing the addition copolymer and a compound that generates an acid on heating or light irradiation (hereinafter also called “thermal acid generator” or “photo-acid generator”, respectively), followed by heating or photo-irradiation of the film or sheet. The film or sheet crosslinked by these procedures is excellent in solvent resistance and chemical resistance.

The thermal acid generator is preferably a thermal acid generator that generates an acid at 50° C. or higher temperatures, which includes, for example, compounds listed in 1) and 2) below.

1) a compound that generates an acid by heating at 50° C. or higher temperatures among aromatic sulfonium salts, aromatic ammonium salts, aromatic pyridinium salts, aromatic phosphonium salts, aromatic iodonium salts, hydrazinium salts, ferrocenium salts, and the like, wherein the counter anion is selected from [BF₄]⁻, [PF₆]⁻, [AsF₆]⁻, [SbF₆]⁻, [B(C₆F₅)₄]⁻, and the like.

2) a compound that generates an acid by heating at 50° C. or higher temperatures in the presence or absence of water or moisture among trialkyl phosphites, triaryl phosphites, dialkyl phosphites, monoalkyl phosphites, phosphinic esters, secondary or tertiary alkyl or cycloalkyl arylphosphonates, secondary or tertiary alkyl esters or cycloalkyl esters of organic phosphoric acid, trialkylsilyl carboxylates, secondary or tertiary alkyl or cycloalkyl carboxylates, secondary or tertiary alkyl ester or cycloalkyl ester of oraganic sulfonic acid, and the like.

Among these, the compound described in 2) is preferable because it has good compatibility with the cyclic olefin addition polymer of the present invention and because the crosslinkable composition is excellent in storage stability.

The photo-acid generator includes onium salts such as diazonium salts, ammonium salts, iodonium salts, sulfonium salts, phosphonium salts, arsonium salts, oxonium salts, and the like; halogenated organic compounds such as halogen-containing oxadiazoles, halogen-containing triazines, halogen-containing benzophenones, and the like; quinonediazides, α,α-bis(sulfonyl)diazomethanes, α-carbonyl-α-sulfonyldiazomethanes, sulfonyl compounds, organic esters, organic amides, organic imides, and the like that generate a Brønsted acid or a Lewis acid by irradiation of g-line, h-line, i-line, ultraviolet light, far-ultraviolet light, X-ray, electron beam, or the like.

The thermal acid generators and photo-acid generators may be used alone or in combination of two or more, and the preferred amount is in a range of 0.001 to 5 parts by weight relative to 100 parts by weight of the cyclic olefin addition copolymer. If the amount is less than 0.001 parts by weight, crosslinking of the cyclic olefin addition copolymer may be insufficient, possibly causing unsatisfactory solvent resistance or chemical resistance of the film or sheet, while if the amount exceeds 5 parts by weight, the resulting crosslinked film or sheet may deteriorate in mechanical strength, electric properties, or transparency.

Furthermore, the composition may comprise the cyclic olefin addition copolymer of the present invention and an antioxidant selected from phenolic antioxidants, lactone-type antioxidants, phosphorous-containing antioxidants, and thioether-type antioxidants, for preventing coloring or deterioration of the copolymer based on increase in oxidation resistance. The antioxidant may be added in a ratio of 0.001 to 5 parts by weight per 100 parts by weight of the copolymer. Specific examples of the antioxidant includes phenolic antioxidants or hydroquinone-type antioxidants such as 2,6-di-t-butyl-4-methylphenol, 4,4′-thiobis(6-t-butyl-3-methylphenol), 1,1-bis(4-hydroxyphenyl)cyclohexane, 2,2′-methylenebis(4-ethyl-6-t-butylphenol), tetrakis[3-(3,5-di-t-butyl-4-hydroxyphenyl)propionylmethyl]methane, stearyl 3-(3,5-di-t-butyl-4-hydroxyphenyl)propionate, 2,5-di-t-butylhydroquinone, and pentaerythrityl terakis[3-(3,5-di-t-butyl-4-hydroxyphenyl)]propionate; phosphorous-containing secondary antioxidants such as bis(2,6-di-t-butyl-4-methylphenyl) pentaerythritol diphosphite, tris(2,4-di-t-butylphenyl) phosphite, tetrakis(2,4-di-t-butyl-5-methylphenyl) 4,4′-biphenylene diphosphonite, diethyl 3,5-di-t-butyl-4-hydroxybenzylphosphonate, bis(2,4-di-t-butylphenyl) pentaerythritol diphosphite, tris(4-methoxy-3,5-di-t-butylphenyl) phosphite, and tris(nonylphenyl) phosphite; sulfur-containing secondary antioxidants such as dilauryl 3,3′-thiodipropionate and 2-mercaptobenzimidazole; and the like.

The cyclic olefin addition copolymer of the present invention may be further blended with another thermoplastic resin to prepare a thermoplastic polymer blend composition for forming a film or sheet. In such a thermoplastic polymer blend composition, another thermoplastic resin is appropriately selected considering the type of the thermoplastic resin, its compatibility with the cyclic olefin addition copolymer, and the purpose of use of the thermoplastic polymer blend composition. Such another thermoplastic resin includes, for example, ring-opening (co)polymers of cyclic olefins and/or hydrogenated derivatives of said (co)polymer, addition copolymers of a cyclic olefin with ethylene and/or an α-olefin, polymethyl methacrylate, polyacrylate, polyethersulfone, polyallylene sulfide, polyethylene, polypropylene, polyester, polyamide, petroleum resin, and the like. In order to obtain a thermoplastic polymer blend composition with excellent heat resistance, the content of another thermoplastic resin is 5 to 95 wt %, preferably 10 to 90 wt %, and more preferably 20 to 70 wt % in 100 wt % of the thermoplastic polymer blend composition.

Since the film or sheet obtained from the cyclic olefin addition polymer of the present invention is excellent in transparency, when provided with, for example, a transparent conductive film such as ITO, a barrier film against oxygen and/or moisture, a hardcoat, an anti-reflection film, or the like as needed, such a film or sheet is applicable to substrates for liquid crystal display elements, optical waveguide, protective films for polarizing plates, retardation films, liquid crystal backlights, touch panels, polarization plates, transparent conductive films, surface-protecting films, OHP films, coating films, infrared filters, and further, optical fibers, lenses, optical discs, and the like.

Further, since the film or sheet obtained from the cyclic olefin addition copolymer of the present invention is excellent in heat resistance, it is also extremely useful as a thin-film coating material applied to surfaces of metal such as copper, silver, gold, and aluminum; ceramics such as glass, silica, titania, zirconia, and alumina; or plastics and as an interlayer coating material or bonding material in laminated bodies when heat resistance is required in such fields. The film or sheet can be also used as an insulating layer material for electronic components, as an adhesive, and further in medical apparatuses, containers, and the like.

### EXAMPLES

Hereinafter, the present invention will be more specifically explained with Examples, but the present invention is not limited to these Examples. The following methods were used to measure or evaluate the molecular weight, glass transition temperature, light transmittance, water absorbency, cracks in film, tensile strength, and ratio of structural units in copolymers.

### (1) Number-Average Molecular Weight and Weight-Average Molecular Weight

Measurement was performed at 120° C. by using o-dichlorobenzene as a solvent, with an H-type column manufactured by Tosoh Corporation, on a gel permeation chromatograph Model-150C manufactured by Waters Corporation. The molecular weight obtained is a value in terms of standard polystyrene.

### (2) Glass Transition Temperature (Tg)

The glass transition temperature of a copolymer was recorded as a peak temperature of tan δ (=E″/E′) calculated from a storage modulus (E′) and a loss modulus (E″) measured with RHEOVIBRON DDV-01FP (manufactured by Orientec Co., Ltd.) under conditions that the measurement frequency was 10 Hz, the heating rate was 4° C./min, the vibration mode was a single waveform, and the vibration amplitude was 2.5 μm.

### (3) Light Transmittance

The light transmittance at a wavelength of 400 nm was determined by recording the light transmittance spectra of a 100-μm thick film formed from a copolymer.

### (4) Water Absorbency

The water absorbency was calculated from the weight difference of a copolymer film between before and after immersion in water at 23° C. for 24 hours.

### (5) Evaluation of Film Toughness (Film Bending Test)

An approximately 100-μm thick film was rolled up to 180° around a steel-made round bar with a diameter of 3 mm and a length of 10 cm, and the presence of breakage and cracking of the film was visually observed. The film toughness was evaluated as follows.

### Good: No film damage such as breakage, wrinkle, and crack was visually observed.

### Do: Not broken, but film damage such as wrinkle and crack was visually observed.

### Poor: Film was broken.

### (6) Tensile Strength and Elongation

The specimen was tested at a tensile rate of 3 mm/min in accordance with JIS K7113.

### (7) Copolymer Composition

The copolymer composition was determined by analyzing monomers remained in a polymer solution after polymerization by gas chromatography (GC).

### Synthesis Example

5-Butylbicyclo[2.2.1]hept-2-ene, 5-hexylbicyclo[2.2.1]hept-2-ene, and 5-trimethylsilylbicyclo[2.2.1]hept-2-ene were synthesized by Diels-Alder reaction and purified under known conditions. The stereoisomer ratio (endo/exo) after purified by distillation was 75/25 in 5-butylbicyclo[2.2.1]hept-2-ene, 80/20 in 5-hexylbicyclo[2.2.1]hept-2-ene, and 60/40 in 5-trimethylsilylbicyclo[2.2.1]hept-2-ene.

### Example 1

A 100-ml pressure-resistant glass reaction vessel was fully purged with nitrogen. Here were charged 22 g of dehydrated toluene, 22 g of dehydrated cyclohexane, and then were added 50 mmol (7.5 g) of 5-butylbicyclo[2.2.1]hept-2-ene obtained in Synthesis Example, 5.48 ml of a 7.66-mol/l dried toluene solution of bicyclo[2.2.1]hept-2-ene (42 mmol), and 0.42 g of styrene. The reaction vessel was tightly sealed with a rubber seal and heated to 75° C. Subsequently, polymerization was started by adding 0.40 ml of a 0.0005-mol/l toluene solution of palladium acetate, 0.10 ml of a 0.002-mol/l toluene solution of tricyclohexylphosphine-triethylaluminum complex, and 0.40 ml of a 0.0005-mol/l toluene solution of triphenylcarbenium tetrakis(pentafluorophenyl)borate. At 45 minutes and 90 minutes after the start of the polymerization, 0.52 ml of the above toluene solution of bicyclo[2.2.1]hept-2-ene was added at each time, and the polymerization was continued for 3 hours in total. The conversion of the total monomers to a polymer was 98%. The resulting copolymer solution was poured to approximately 1 L of isopropyl alcohol to obtain precipitate, which was dried at 80° C. under vacuum for 17 hours to obtain cyclic olefin addition copolymer A (hereinafter also called “copolymer A”). In copolymer A, the content of 5-butylbicyclo[2.2.1]hept-2-ene-derived unit was 50 mol %, the number-average molecular weight was 47,000, and the weight-average molecular weight was 198,000.

A solution was prepared by dissolving 0.5 parts by weight of pentaerythrityl tetrakis[3-(3,5-di-t-butyl-4-hydroxyphenyl)]propionate and 0.5 parts by weight of tris(2,4-di-t-butylphenyl)phosphite as antioxidants relative to 100 parts by weight of copolymer A in a mixed solvent comprising 280 parts by weight of cyclohexane and 70 parts by weight of toluene. This solution was cast at 25° C., the solvents were gradually evaporated until the residual solvent was approximately 12%, and the cast film was subsequently maintained at 200° C. for 90 minutes to obtain film A with a thickness of 100 μm. As shown in the evaluation results in Table 1, film A exhibited excellent transparency, excellent toughness, and low water absorbency.

### Example 2

A 100-ml pressure-resistant glass reaction vessel was fully purged with nitrogen. Here were charged 22 g of dehydrated toluene and 22 g of dehydrated cyclohexane, and then were added 40 mmol (6.0 g) of 5-butylbicyclo[2.2.1]hept-2-ene obtained in Synthesis Example, 6.53 ml of a 7.66-mol/l dried toluene solution of bicyclo[2.2.1]hept-2-ene (50 mmol), and 0.42 g of styrene. The reaction vessel was tightly sealed with a rubber seal and heated to 75° C. Subsequently, polymerization was started in the same procedure as Example 1. At 45 minutes and 90 minutes after the start of the polymerization, 0.65 ml of the above toluene solution of bicyclo[2.2.1]hept-2-ene was added at each time, and the polymerization was continued for 3 hours in total. The conversion of the total monomers to a polymer was 99%, and the polymerization solution was always transparent. By the same procedures as Example 1, cyclic olefin addition copolymer B (hereinafter also called “copolymer B”) was obtained from the resulting copolymer solution. Copolymer B was dissolved in cyclohexane, methylcyclohexane, and o-dichlorobenzene at 25° C. to give a transparent solution in a concentration of 10 wt %. In copolymer B, the content of 5-butylbicyclo[2.2.1]hept-2-ene-derived unit was 39 mol %, the number-average molecular weight was 48,000 and the weight-average molecular weight was 210,000.

By the same procedures as Example 1, film B with a thickness of 100 μm was obtained from copolymer B. As shown in the evaluation results in Table 1, film B exhibited excellent transparency, excellent toughness, and low water absorbency.

### Example 3

By the same procedures as Example 2 except that the volume of the dried toluene solution of bicyclo[2.2.1]hept-2-ene initially added was 7.83 ml (60 mmol) and that no dried toluene solution of bicyclo[2.2.1]hept-2-ene was added thereafter, cyclic olefin addition copolymer C (hereinafter also called “copolymer C”) was obtained at a conversion rate of 95%. The copolymer C resulted in a slightly white opaque solution at a concentration of 10 wt % in cyclohexane at 25° C. In copolymer C, the content of 5-butylbicyclo[2.2.1]hept-2-ene-derived unit was 37 mol %, the number-average molecular weight was 57,000, and the weight-average molecular weight was 221,000.

By the same procedures as Example 1, film C with a thickness of 100 μm was obtained from copolymer C. As shown in the evaluation results in Table 1, film C exhibited excellent transparency, excellent toughness, and low water absorbency.

### Comparative Example 1

A 100-ml pressure-resistant glass reaction vessel was fully purged with nitrogen. Here were charged 22 g of dehydrated toluene and 22 g of dehydrated cyclohexane, and then were added 100 mmol (15.0 g) of 5-butylbicyclo[2.2.1]hept-2-ene obtained in Synthesis Example and 0.26 g of styrene. The reaction vessel was tightly sealed with a rubber seal and heated to 75° C. The polymerization was performed for 3 hours in the same procedure as Example 1 except that no additional monomer was fed. The conversion of the total monomers to a polymer was 95%. The polymerization reaction solution gradually started to cloud when the conversion exceeded 80% and became opaque at the end of the polymerization. By the same procedures as Example 1, cyclic olefin addition copolymer D (hereinafter also called “polymer D”) was obtained from the resulting polymer solution. Polymer D was not homogeneously dissolved in any of cyclohexane, methylcyclohexane, toluene, and o-dichlorobenzene at 25° C. at a concentration of 10 wt %, resulting in a clouded solution. The copolymer D had a number-average molecular weight of 47,000 and a weight-average molecular weight of 203,000.

By the same procedures as Example 1, film D with a thickness of 100 μm was obtained from copolymer D. As shown in the evaluation results in Table 1, film D was clearly inferior in transparency and not suitable as an optical material. In addition, the results of the tensile testing indicated that the breaking strength of film D was significantly inferior to that of films A to C.

### Comparative Example 2

By the same procedures as Example 1 except that 50 mmol of 5-hexylbicyclo[2.2.1]hept-2-ene obtained by Synthesis Example was used in place of 5-butylbicyclo[2.2.1]hept-2-ene, cyclic olefin addition copolymer E (hereinafter also called “polymer E”) was obtained at a conversion rate of 98%, and film E was obtained from copolymer E. In copolymer E, the content of 5-hexylbicyclo[2.2.1]hept-2-ene-derived unit was 49 mol %, the number-average molecular weight was 41,000, and the weight-average molecular weight was 181,000. As shown in the evaluation results in Table 1, film E was inferior in breaking strength.

### Example 4

In a fully nitrogen-purged 100-ml pressure-resistant glass reaction vessel, were charged 22 g of dehydrated toluene and 22 g of dehydrated cyclohexane, and then were added 50 mmol (7.5 g) of 5-butylbicyclo[2.2.1]hept-2-ene obtained in Synthesis Example and 5.48 ml of a 7.66-mol/l dried toluene solution of bicyclo[2.2.1]hept-2-ene (42 mmol). The reaction vessel was tightly sealed with a rubber seal, ethylene was fed herein at a rate of 60 ml/min for 12 sec, and the content was heated to 75° C. Subsequently, polymerization was started by adding 0.40 ml of a 0.0005-mol/l toluene solution of palladium acetate, 0.10 ml of a 0.002-mol/l toluene solution of tricyclohexylphosphine, and 0.40 ml of a 0.0005-mol/l toluene solution of triphenylcarbenium tetrakis(pentafluorophenyl)borate. At 45 minutes and 90 minutes after the start of the polymerization, 0.52 ml of the above toluene solution of bicyclo[2.2.1]hept-2-ene was added at each time, and the polymerization was continued for 3 hours in total. The conversion of the total monomers to a polymer was 98%, and the polymerization solution was slightly cloudy and translucent at the end of the polymerization. By the same procedures as Example 1, cyclic olefin addition copolymer F (hereinafter also called “copolymer F”) was obtained from the resulting copolymer solution. Copolymer F was dissolved to cyclohexane, methylcyclohexane, and o-dichlorobenzene at 25° C. to give a transparent solution at a concentration of 10 wt %. In copolymer F, the content of 5-butylbicyclo[2.2.1]hept-2-ene-derived unit was 50 mol %, the number-average molecular weight was 47,000, and the weight-average molecular weight was 201,000.

A solution was prepared by dissolving 0.5 parts by weight of pentaerythrityl tetrakis[3-(3,5-di-t-butyl-4-hydroxyphenyl)]propionate and 0.5 parts by weight of tris(2,4-di-t-butylphenyl) phosphite as antioxidants relative to 100 parts by weight of copolymer F in a mixed solvent comprising 280 parts by weight of cyclohexane and 70 parts by weight of toluene. This solution was cast at 25° C., the solvents were gradually evaporated until the residual solvent was approximately 12%, and the cast film was maintained at 200° C. for 90 minutes to prepare film F with a thickness of 100 μm. As shown in the evaluation results in Table 1, film F was excellent in transparency, heat resistance, toughness, and low water absorbency.

### Comparative Example 3

When the same procedures as Example 4 were performed except that no tricyclohexylphosphine was added, the polymerization did not proceed. In contrast, when the same procedures as Example 4 were performed except that the concentrations of the toluene solution of palladium acetate and the toluene solution of triphenylcarbenium tetrakis(pentafluorophenyl)borate were 0.005 mol/l respectively, and that 5.0 ml of each of the toluene solutions was added but with no tricyclohexylphosphine, the polymerization proceeded. Cyclic olefin addition copolymer G (hereinafter also called “copolymer G”) was obtained at a conversion of 85%. Copolymer G resulted in a slightly opaque solution at a concentration of 10 wt % in cyclohexane at 25° C. Copolymer G was not homogeneously dissolved in toluene and gave an intensely clouded mixture. In copolymer G, the content of 5-butylbicyclo[2.2.1]hept-2-ene-derived unit was 50 mol %, the number-average molecular weight was 83,000, and the weight-average molecular weight was 244,000.

By the same procedures as Example 1, film G with a thickness of 100 μm was formed from copolymer G. Film G was inferior in transparency because it was brown-colored and cloudy. In addition, film G was poor in breaking strength and brittle.

### Comparative Example 4

A 100-ml pressure-resistant glass vessel was fully purged with nitrogen. Here were charged 22 g of dehydrated toluene and 22 g of dehydrated cyclohexane, and then was added 13.1 ml of a 7.66-mol/l dried toluene solution of bicyclo[2.2.1]hept-2-ene (100 mmol). The vessel was tightly sealed with a rubber seal, ethylene was fed herein at a rate of 120 ml/min for 15 sec, and the mixture was heated to 75° C. Subsequently, polymerization was started by adding 0.25 ml of a 0.0005-mol/l toluene solution of palladium acetate, 0.10 ml of a 0.001-mol/l toluene solution of tricyclohexylphosphine, and 0.25 ml of a 0.0005-mol/l toluene solution of triphenylcarbenium tetrakis(pentafluorophenyl) borate without feeding additional monomer and the polymerization was continued for 2 hours. The conversion rate of the total monomers to a polymer was not less than 99%. The polymerization solution gradually started to cloud when the conversion exceeded 70%. At the end of the polymerization, the solution was opaque and had extremely decreased fluidity. Part of the polymer solution was separated, diluted with cyclohexane, and poured into isopropyl alcohol to give precipitate, which was dried under vacuum at 80° C. for 17 hours to obtain cyclic olefin addition polymer H (hereinafter also called “polymer H”). When polymer H was added to cyclohexane, methylcyclohexane, or o-dichlorobenzene at a concentration of 10 wt % at 25° C., it was not homogeneously dissolved in any of these solvents, the mixture was intensely clouded, and insoluble components were observed. Polymer H was only swollen in toluene, whereas it was homogeneously dissolved in o-dichlorobenzene heated at 100° C. at a concentration of 5 wt % or less. Polymer H had a number-average molecular weight of 59,000 and a weight-average molecular weight of 221,000.

Film H was formed by the following procedure without isolating polymer H from the resulting polymer solution. That is, the solution was diluted by adding 100 parts by weight of cyclohexane relative to 100 parts by weight of polymer H in the solution, and here were added 0.5 parts by weight of pentaerythrityl tetrakis[3-(3,5-di-t-butyl-4-hydroxyphenyl)]propionate and 0.5 parts by weight of tris(2,4-di-t-butylphenyl) phosphite as antioxidants to give a clouded solution. The clouded solution was cast at 25° C., the solvents were gradually evaporated until the residual solvent was approximately 12%, and the cast film was maintained at 200° C. for 90 minutes to obtain film H. Film H had significantly uneven film thickness, and as shown in the evaluation results in Table 1, was poor in transparency, apparently inferior in toughness, and brittle.

### Comparative Example 5

A 100-ml pressure-resistant glass reaction vessel was fully purged with nitrogen. Here were charged 15 g of dehydrated nitromethane and 25 g of dehydrated toluene, and then were added 50 mmol (8.9 g) of 5-hexylbicyclo[2.2.1]hept-2-ene obtained in Synthesis Example and 6.53 ml of a 7.66-mol/l dried toluene solution of bicyclo[2.2.1]hept-2-ene (50 mmol). The reaction vessel was tightly sealed with a rubber seal and the temperature was maintained at 20° C. To the reaction solution was added 0.1 ml of a 0.01-mol/l toluene solution of tetrakis(acetonitrile)palladium tetrafluoroborate [Pd(CH₃CN)₄] (BF₄)₂, but the polymerization did not proceed. When the catalyst was further added until the volume summed to 6 ml, the polymerization started. The reaction was conducted for 90 minutes without feeding additional monomers. The conversion of the total monomers to a polymer was 78%. By the same procedures as Example 1, cyclic olefin addition copolymer I (hereinafter also called “copolymer I”) was obtained from the resulting copolymer solution. Copolymer I was transparently dissolved at a concentration of 10 wt % in cyclohexane, methylcyclohexane, and o-dichlorobenzene at 25° C. In copolymer I, the content of 5-hexylbicyclo[2.2.1]hept-2-ene-derived unit was 47 mol %, the number-average molecular weight was 54,000, and the weight-average molecular weight was 146,000.

By the same procedures as Example 1, film I with a thickness of 100 μm was formed from copolymer I. As shown in the evaluation results in Table 1, film I had a low glass transition temperature, and was poor in heat resistance and toughness. In addition, film I was brown-colored.

### Comparative Example 6

A 100-ml pressure-resistant glass reaction vessel was fully purged with nitrogen. Here were charged 45 g of dehydrated cyclohexane, 50 mmol (7.5 g) of 5-butylbicyclo[2.2.1]hept-2-ene obtained in Synthesis Example, 6.53 ml of a 7.66-mol/l dried toluene solution of bicyclo[2.2.1]hept-2-ene (50 mmol), and 2.0 mmol of 1-hexene dissolved in toluene. The reaction vessel was tightly sealed with a rubber seal and the temperature was adjusted to 30° C. Subsequently, the polymerization was started by adding 0.020 mmol of nickel octanoate, 0.14 mmol of tris(pentafluorophenyl)borane and 0.40 mmol of triethylaluminum, each of which was dissolved in toluene, and the reaction was performed for 1 hour without feeding additional monomer. The conversion of total monomers to a polymer was 91%. The polymerization solution was poured into approximately one liter of isopropyl alcohol containing 2 g of lactic acid to give precipitate, which was dried under vacuum at 80° C. for 17 hours to obtain cyclic olefin addition copolymer J (hereinafter also called “copolymer J”). Copolymer J was transparently dissolved at a concentration of 10 wt % in toluene, cyclohexane, methylcyclohexane, and o-dichlorobenzene at 25° C. In copolymer J, the content of 5-butylbicyclo[2.2.1]hept-2-ene-derived unit was 49 mol %, the number-average molecular weight was 57,000, and the weight-average molecular weight was 210,000.

By the same procedures as Example 1, film J with a thickness of 100 μm was formed from copolymer J. As shown in the evaluation results in Table 1, film J had good transparency and heat resistance but was inferior in mechanical strength and brittle.

### Example 5

A 100-ml pressure-resistant glass reaction vessel was fully purged with nitrogen. Here were charged 44 g of dehydrated toluene, and then 10 mmol (1.7 g) of 5-trimethylsilylbicyclo[2.2.1]hept-2-ene obtained in Synthesis Example and 9.4 ml of a 7.66-mol/l dried toluene solution of bicyclo[2.2.1]hept-2-ene (72 mmol). The reaction vessel was tightly sealed with a rubber seal, ethylene was fed at a rate of 60 ml/min for 14 sec, and the reaction system was heated to 75° C. The polymerization was started by adding 0.40 ml of a 0.0005-mol/l toluene solution of palladium acetate, 0.10 ml of a 0.002-mol/l toluene solution of tricyclohexylphosphine, and 0.40 ml of a 0.0005-mol/l toluene solution of triphenylcarbenium tetrakis(pentafluorophenyl)borate. At 45 minutes after the start of the polymerization, 2.35 ml of the above toluene solution of bicyclo[2.2.1]hept-2-ene was added, and the polymerization was continued for three hours in total. The conversion of the total monomers to a polymer was 99% and the polymer solution was slightly cloudy and translucent at the end of the polymerization. By the same procedures as Example 1, cyclic olefin addition copolymer K (hereinafter also called “copolymer K”) was obtained from the resulting copolymer solution. Copolymer K was transparently dissolved at a concentration of 10 wt % in cyclohexane, methylcyclohexane, and o-dichlorobenzene at 25° C. In copolymer K, the content of 5-trimethylsilylbicyclo[2.2.1]hept-2-ene-derived unit was 10 mol %, the number-average molecular weight was 51,000, and the weight-average molecular weight was 200,000.

A solution was prepared by dissolving 0.5 parts by weight of pentaerythrityl tetrakis[3-(3,5-di-t-butyl-4-hydroxyphenyl)]propionate and 0.5 parts by weight of tris(2,4-di-t-butylphenyl) phosphite as antioxidants relative to 100 parts by weight of copolymer K in a mixed solvent comprising 280 parts by weight of cyclohexane and 70 parts by weight of toluene. The solution was cast at 25° C., the solvents were gradually evaporated until the residual solvent was approximately 12%, and the cast film was subsequently maintained at 200° C. for 90 minutes to obtain film K with a thickness of 100 μm. As shown in the evaluation results in Table 1, film K was excellent in transparency, heat resistance, toughness, and low water absorbency.

TABLE 1

| | | | Light | Water | | Breaking |
|---|---|---|---|---|---|---|
| | | Tg | Transmittance | absorbency | Bending | Strength/Elongation |
| | Film | (° C.) | (%) | (%) | Test | (MPa/%) |
| Example 1 | A | 355 | 91 | <0.1 | Good | 46/7.4 |
| Example 2 | B | 360 | 91 | <0.1 | Good | 49/6.7 |
| Example 3 | C | 360 | 88 | <0.1 | Good | 48/6.7 |
| Comparative | D | 300 | 70 | <0.1 | Good | 18/12 |
| Example 1 | | | | | | |
| Comparative | E | 310 | 91 | <0.1 | Good | 25/9.0 |
| Example 2 | | | | | | |
| Example 4 | F | 350 | 90 | <0.1 | Good | 45/7.7 |
| Comparative | G | 345 | 81 | <0.1 | ″ | 28/5.8 |
| Example 3 | | | | | | |
| Comparative | H | 390 | 73 | <0.1 | Poor | 65/8.0 |
| Example 4 | | | | | | |
| Comparative | I | 180 | 89 | <0.1 | ″ | 25/8.0 |
| Example 5 | | | | | | |
| Comparative | J | 355 | 91 | <0.1 | Poor | 18/2.0 |
| Example 6 | | | | | | |
| Example 5 | K | 365 | 91 | <0.1 | Good | 65/9.8 |

### INDUSTRIAL AVAILABILITY

The present invention can provide a cyclic olefin addition copolymer that is excellent in transparency, heat resistance, low water absorbency, mechanical strength, smoothness, and toughness in a form such as film and sheet and can be formed by solution-casting using a hydrocarbon solvent. This cyclic olefin addition copolymer, when provided with, for example, a transparent conductive film such as ITO, a barrier film against oxygen and/or moisture, a hardcoat, or an anti-reflection film as necessary, may be used in substrates for liquid crystal display elements, optical waveguides, protection films for polarizing plate, retarding films, liquid crystal backlights, touch panels, polarization plates, transparent conductive films, surface-protecting films, OHP films, coating films, infrared filters, and further optical fibers, lenses, optical discs, and the like. Furthermore, the copolymer can be also used as an insulating layer material of electronic components, as an adhesive, and further in medical apparatuses, containers, and the like.

1. A method for producing a cyclic olefin addition copolymer wherein a monomer composition containing
(1) 5 to 80 mol % of a cyclic olefin having a substituent selected from alkyl groups, the alkylsilyl group, and the alkylsilylmethyl group represented by formula (1) below and
(2) 20 to 95 mol % of a cyclic olefin represented by formula (2) below, provided that the total amount of monomers in said monomer composition is 100 mol %,
is addition-copolymerized in the presence of a palladium-based multicomponent catalyst containing
(i) a palladium compound selected from the group consisting of organic acid salts of palladium, β-diketone complexes of palladium, complexes with a ligand capable of coordinating to palladium through a phosphorous atom therein, and palladium complexes coordinated by a carbon-carbon double bond,
(ii) a phosphorus compound selected from the group consisting of phosphines that contain (a) substituent (s) selected from the group consisting of alkyl groups having 3 to 15 carbon atoms, cycloalkyl groups having 3 to 15 carbon atoms, and aryl groups having 6 to 15 carbon atoms and have a cone angle (0 in deg) of 170 to 200°, phosphonium salts derived from said phosphines, and complexes of said phosphines with organoaluminum compounds, and
(iii) an ionic boron compound or an ionic aluminum compound: 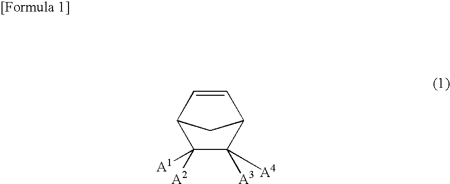
in formula (1), one of A¹ to A⁴ is an alkyl group having 4 or carbon atoms, a trimethylsilyl group, or a trimethylsilylmethyl group, and the others each independently are a hydrogen atom, a halogen atom, or a methyl group; and 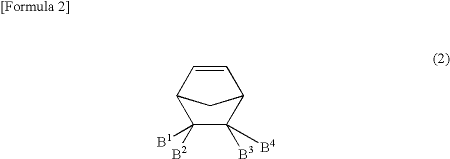
in formula (2), B¹ to B⁴ each independently are a hydrogen atom, a methyl group, or a halogen atom.

2. The method for producing the cyclic olefin addition copolymer according to claim 1 comprising a step of starting the polymerization using 20 to 95% by weight of the total amount of said cyclic olefin (2) and a step of further feeding the residual part of said cyclic olefin (2) during the polymerization.

3. A cyclic olefin addition copolymer that contains 5 to 80 mol % of a structural units represented by formula (3) below and 20 to 95 mol % of a structural units represented by formula (4) below, provided that the total of the structural units in said copolymer is 100 mol %, and has a light transmittance of not less than 85% at a wavelength of 400 nm when formed into a 100-μm thick film: 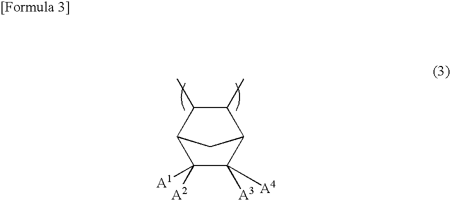
wherein, in formula (3), one of A¹ to A⁴ is an alkyl group having 4 to 5 carbon atoms, a trimethylsilyl group, or a trimethylsilylmethyl group, and the others each independently are a hydrogen atom, a halogen atom, or a methyl group; and 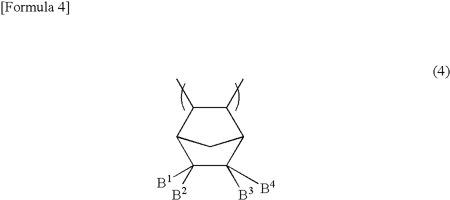
in formula (4), B¹ to B⁴ each independently are a hydrogen atom, a methyl group, or a halogen atom.

4. The cyclic olefin addition copolymer according to claim 3 obtained by the method according to claim 1 or 2.

5. A film or a sheet formed from the cyclic olefin addition copolymer according to claim 3 or 4.
